(19) United States
(12) Patent Application Publication
(10) Pub. No.: US 2022/0107425 A1
(43) Pub. Date: Apr. 7, 2022

(54) System and Method for Overcoming GPS-Denied Environments

(71) Applicant: Bevilacqua Research Corporation, Inc, Huntsville, AL (US)

(72) Inventors: James J. Hornsby, Pensacola, FL (US); Andy Bevilacqua, Huntsville, AL (US)

(73) Assignee: Bevilacqua Research Corporation, Inc, Huntsville, AL (US)

(21) Appl. No.: 17/062,116

(22) Filed: Oct. 2, 2020

(51) Int. Cl. G01S 19/25; G01S 19/31; G01S 19/34; H04W 84/18; H04B 1/3827

(52) U.S. Cl. CPC G01S 19/256; G01S 19/31; H04B 1/385; H04W 84/18; G01S 19/34

(57) ABSTRACT

A variety of methods and devices for a low-probability of intercept, low probability of denial (LPI/LPD) method of providing RF signals in denied spaces are disclosed. A phased array antenna converts an omnidirectional communication system into a highly directional system. This factor coupled with the precise timing between the transmit and receive sets, establishes a precise distance measurement between the two sets. Using three or more transceivers enables the composition of an ad hoc network of nodes that can be used to establish an available mesh of position and timing that can be accessed by operators within the radio boundaries of the mesh. Portable transceivers reestablish position, navigation and timing (PNT), thereby forming an ad-hoc network. Where the ad-hoc network PNT mesh can intersect with a GPS signal that is outside of the denied environment, the ad-hoc network mesh can detect the GPS position and timing.

### BACKGROUND OF THE INVENTION

The nature of soil and concrete has always made geophysical spaces resistant to electronic communications. The concept of “denied” spaces includes above-ground as well. Spaces such as urban areas with tall concrete buildings, anti-access, area denial (A2AD) spaces (with and without jamming) and spaces with little or no communications infrastructure or access to global positioning system (GPS) are all common problem areas, including for e.g. the U.S. military. With sufficient power, RF communications can still be established in this kind of resource-denied (e.g. GPS-denied) area. However, the size, weight and power requirements needed make the use of such equipment is often prohibitive.

Many military, and civilian, missions are heavily reliant on maintaining precision position, navigation, and timing, predominantly through the use of the global positioning system (GPS), and are negatively impacted when GPS signals are absent or degraded due to environmental obscuration or radio interference. GPS can be blocked by the same environmental considerations that other communications signals are.

To address these issues, the embodiments herein can generate high output power using small low-power components that are easily transported by human or small air platforms. This results in a significant advancement in the field of denied-area communications.

### SUMMARY OF THE INVENTION

The disclosed embodiments relate generally to methods and devices for a low-probability of intercept, low probability of denial (LPI/LPD) method of providing RF signals in denied spaces.

A phased array antenna converts an omnidirectional communication system into a highly directional system. This factor coupled with the precise timing between the transmit and receive sets, establishes a precise distance measurement between the two sets. Using three or more transceivers enables the composition of an ad hoc network of nodes that can be used to establish an available mesh of position and timing that can be accessed by operators within the radio boundaries of the mesh. Small, portable ‘puck’ or ‘brick’ transceivers that can be dropped or emplaced by dismounted soldiers operating in the GPS-denied environments to reestablish position, navigation and timing (PNT), thereby forming an ad-hoc network.

Where the ad-hoc network PNT mesh can intersect with a GPS signal that is outside of the denied environment, the ad-hoc network mesh can pick up the GPS position and timing and carry them into the ad-hoc network net and extend GPS capability into areas otherwise denied.

The addition of a phased array antenna converts the invention from an omnidirectional communication system into a directional system. This modification, coupled with the common time base being maintained between the transmit and receive sets, establishes a distance measurement between the two transceivers and an error of less than 1 meter. Using three or more transceivers enables the composition of a network of nodes that can be used to establish an available mesh of position and timing that can be accessed by operators within the boundaries of the mesh. Because of the use of small low power elements, an embodiment of this invention can be made sufficiently small, and lightweight to produce handheld ‘puck’ or ‘brick’ transceivers that can be dropped or placed by personnel operating in the GPS denied environments to establish position, navigation and timing (PNT). This localized PNT mesh can then be extended to a region beyond the denied environment where a GPS signal can be received. Once the GPS connection is established, the local PNT can be coupled with the GPS to provide a global geo-reference into the denied environment. This capability extends well beyond traditional military missions and includes first responders in the civil sector that are performing search and rescue, recovery, and civil defense roles as well as other industries that benefit from assured PNT in environmentally denied GPS scenarios.

The phased-array antenna is further enhanced with the addition of an image processing technique to achieve a sense-through-wall radar capability. Originally developed for sensitive site exploitation missions, this sense-through-walls radar combines the structure penetration capabilities of the original parent embodiment for low probability of detection performance with the ability to discern structural details behind soil or concrete, identifying the placement and relationships of walls and voids as well as recognition of items or people within a structure or natural cavity. Using the disclosed transceiver hardware enables transport of the sense-through-walls capability via man pack by dismounted troops, small manned or unmanned ground vehicles, or small unmanned air systems.

The sense-through-walls inventive device, utilizes low power and extremely short duty cycles, resulting in low probability of detection by adversaries in or associated with the structure. Undetected operations provides a permissive environment for the sense-through-walls radar to develop a detailed assessment of the structure of interest, its contents, and the nature of the operations associated with the structure.

Further, the disclosed image processing techniques discussed herein use detailed behavior signatures of the processed imagery to interpret the activity associated with the structure, contents, and occupants. Applications of this technology will, logically, extend into the first responder, civil defense, and law enforcement missions providing the ability to maintain safe distances from ongoing operations with detailed eyes on and in the area of interest.

In an embodiment, a system containing a phased array antenna sends and receives signals whose angular pointing is management through a beamforming process. An A2D-D2A, transceiver, BPF, and beam forming process are all controlled through digital signal processors (DSPs) that are, in turn managed through controls from an embedded microprocessor. Accurate timing between the inventive units is maintained using precise clocks that have been synchronized during a calibration sequence prior to distribution and operation.

Within the embodiments herein, machine learning processing predicts swings in a reference clock due to temperature changes or other environment effects and compensates by dynamically correcting the location calculations. When multiple units are being operated as a single system, any units in conflict with the ensemble situational awareness model are tagged as outliers. When the error is relatively small and predictable, the units are dynamically recalibrated. If the detected anomaly is too large or too unpredictable, the unit is designated as a non-contributing member of the ensemble and is demoted to a simple transceiver. This permits continued use of the unit at some level of functionality without degrading the performance of the system.

The embodiments herein use a highly accurate clock to maintain precise time between transmitted and received pulses to achieve the aforementioned operation in GPS-denied environments. This feature can be further exploited using multiple inventive transceivers whose internal clocks have been synchronized to maintain a highly accurate relative positions between transceiver units. With the addition of a directional heading measurement such as a digital compass, a set of these transceivers can maintain absolute position upon entering a region in which GPS signals are blocked, jammed, or spoofed. This capability is achievable with a single antenna element but is further enhanced using an antenna array such as a 4×4 phased antenna array.

Position, navigation and timing (PNT) are achieved by utilizing a clock-controlled range timer and translating the beam steering information obtained from transceivers to accurately determine position and timing with respect to a local area base radio in an active operating region (theater). An ad-hoc network of pucks/bricks can furnish position and timing of each transceiver to an adjacent area, until finally one of these transceivers is located outside of the GPS-denied region. Since all local transceiver coordinates have been translated through the chain, the final friendly area base radio can furnish position and timing relative to GPS coordinates to the command station.

### BRIEF DESCRIPTION OF THE DRAWINGS

FIG. 1 shows a system which communicates directly or indirectly through an ad-hoc (real-time dynamic) network located in an area in which some type of emergency or important or high-risk activity is taking place;

FIG. 2 shows components of some electronic components within the system of FIG. 1;

FIG. 3 shows an example operation sequence of a Field Programmable Gate Array within the electronic components of FIG. 2;

FIG. 4 shows an example arrangement of a phased antenna array;

FIG. 5 shows example arrangements of distance, azimuth degrees, and elevation degrees of transceivers;

FIG. 6 shows some separate business models for the system of FIG. 1;

FIG. 7A (Tehran) illustrates an example GUI displaying components of the system of FIG. 1;

FIG. 7B (Bin-Laden compound) illustrates another example GUI displaying components of the system of FIG. 1;

FIG. 7C-7D (wildfires) show example GUIs displaying components of the system of FIG. 1; and

FIG. 7E (street) and FIG. 7F (helicopter) show example GUIs in a law-enforcement usage of the system of FIG. 1.

### DETAILED DESCRIPTION OF THE PREFERRED EMBODIMENTS

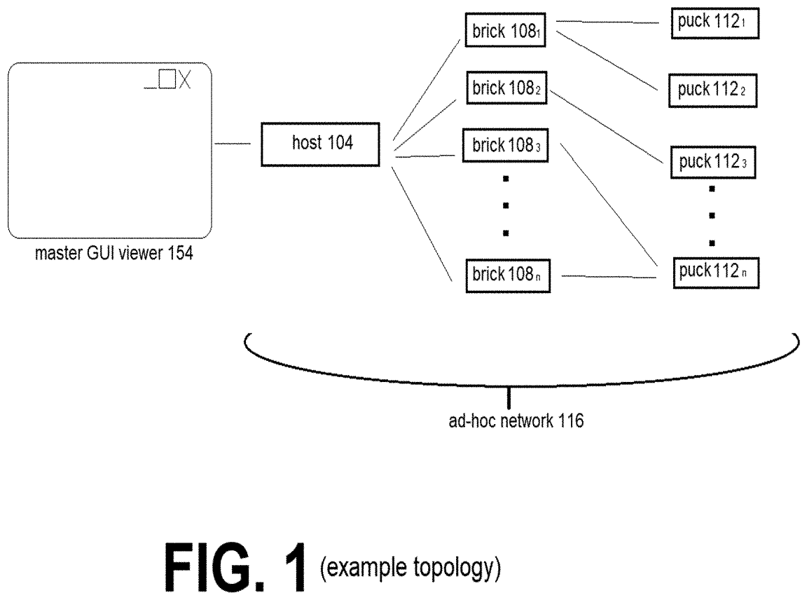

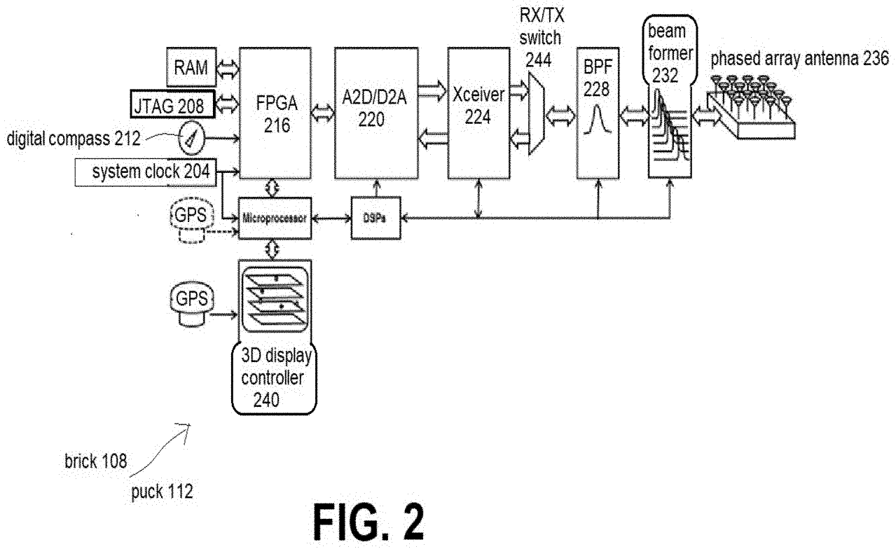

FIG. 1 shows a system 100 which communicates directly or indirectly through an ad-hoc (real-time dynamic) network 116 located in an area in which some type of emergency or important or high-risk activity is taking place, known as an active operating region. In an embodiment, the system 100 comprises a master host 104 and one or more pucks 108 and bricks 112 forming the ad-hoc network 116 which communicates positional and other information to a master (executive dashboard) GUI viewer 154 which may be located within or outside of the active operation region. Within this disclosure, the bricks 108 and pucks 112 are sometimes collectively referred to as “mobile units”. As shown in FIG. 2, these mobile units are equipped with a GPS receiver that can (assuming sufficient GPS signal) convert the relative location information being received from the mobile units (bricks 108, pucks 112) into an absolute geolocation and heading which can then be re-distributed to all mobile units throughout the ad-hoc network 116.

As will be discussed in more detail with respect to FIG. 2, even if none of the elements of the ad-hoc network 116 can get outside the GPS-denied area, accurate position can still be obtained for all elements by the combination of an accurate, reliable system clock 204 and a digital compass 212.

In an embodiment, firefighters, military, law enforcement, or other workers, would wear the pucks 112 sewn or embedded within their clothing. These workers (puck-bearers), perhaps running into a fire area or active shooter area at a school, or special forces, might first quickly post a brick 108 perhaps 9 feet off the ground as they are busy running in. The bricks 108 are light-weight and have strong adhesive. The workers (puck-bearers) may post another brick 108 as they get in closer. The workers typically have the pucks 112 positioned on their hip about the same level as their keys, mobile device, or belt buckle. Using this arrangement, supervisory persons can see and track where the workers (puck-bearers) are located by operating the master GUI viewer 154.

### Composition of Bricks 108 and Pucks 112

As shown in FIG. 2, the major components of the electronic circuitry of the bricks\pucks 108\112 comprise a floating point gate array (FPGA) 216 to manage the low-level processing and communications functions; an Analog2Digital/Digital2Analog (A2D-D2A) converter 220 to handle the incoming and outgoing signals through the transceiver; and a bidirectional receive/transmit (RX/TX) switch 244 feeding an adaptive bandpass filter (BPF) 228.

The bricks 108 would not differ from the pucks 112 in electronic components, but instead would be shaped differently and have different locations. In an embodiment, the bricks 108 would be rectangular, hence the word brick, and once the ad-hoc network 116 is activated, would likely be mounted on a surface and then remain stationary. Meanwhile, the pucks 112 would be smaller, perhaps in a round or disc-shape, to be sewn into clothing or apparel or gear. The pucks would likely be worn be the individual workers performing the various tasks in the various operating environments described herein, e.g. fire-fighting, law enforcement including riot control, special forces tasks such as the Bin Laden raid, embassy raid, or other dangerous tasks.

Within FIG. 2, one GPS component is drawn in dashed line, meaning that this GPS component may be defeated or rendered inactive due to environment, jamming, or other circumstances. Meanwhile, the other GPS component is drawn in solid line, meaning that GPS information or GPS-like information is constructed or reconstructed by the embodiments herein.

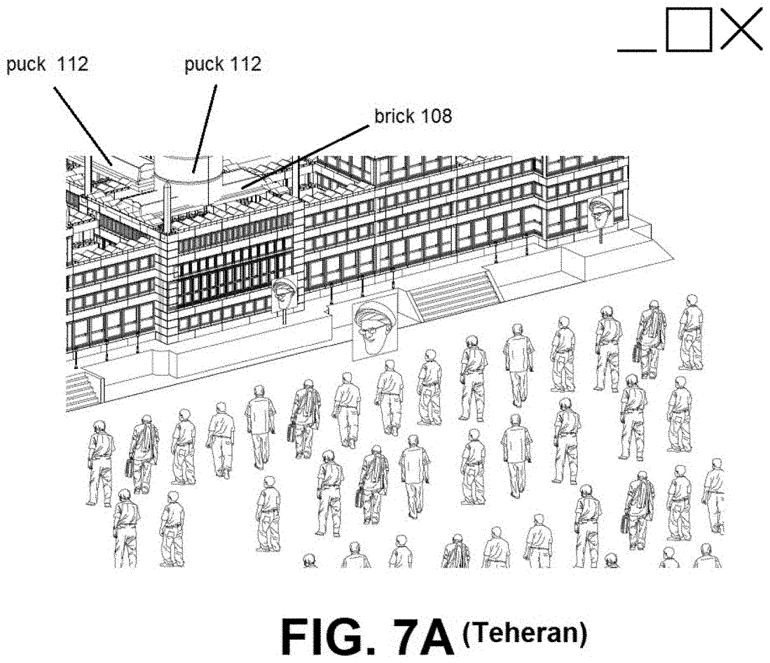

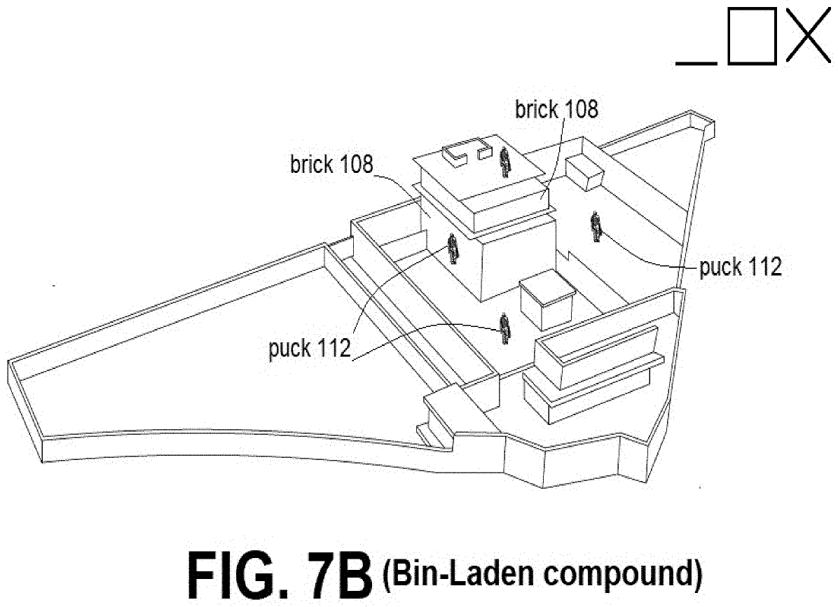

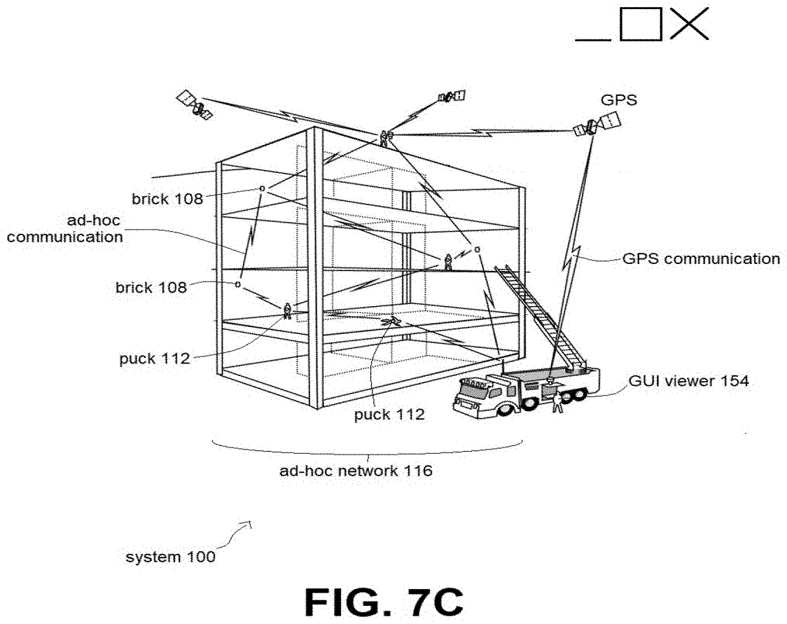

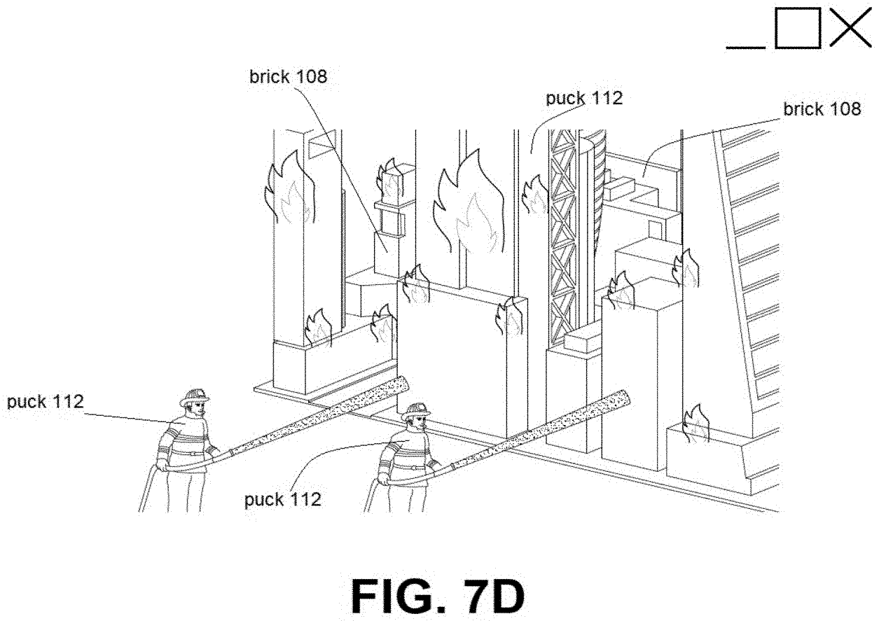

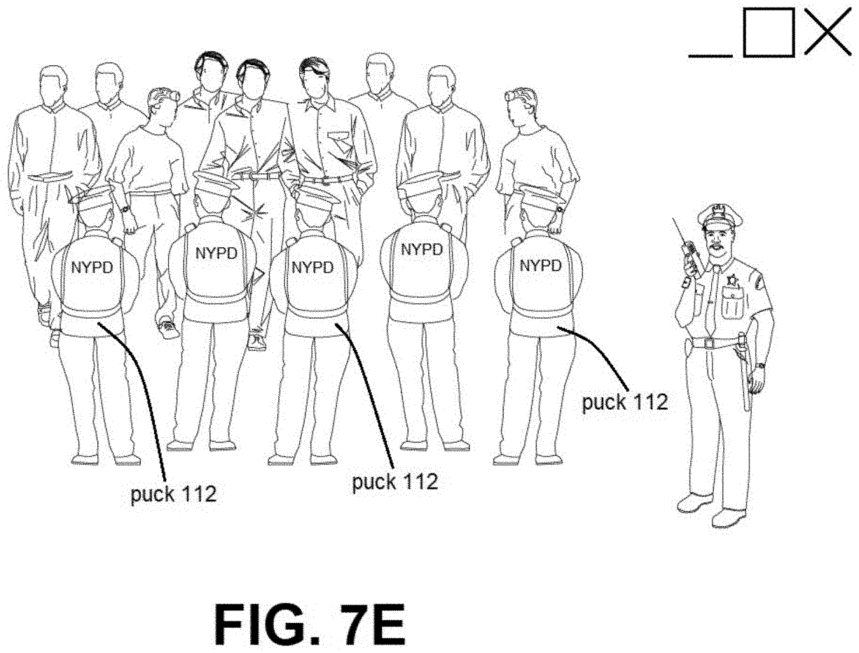

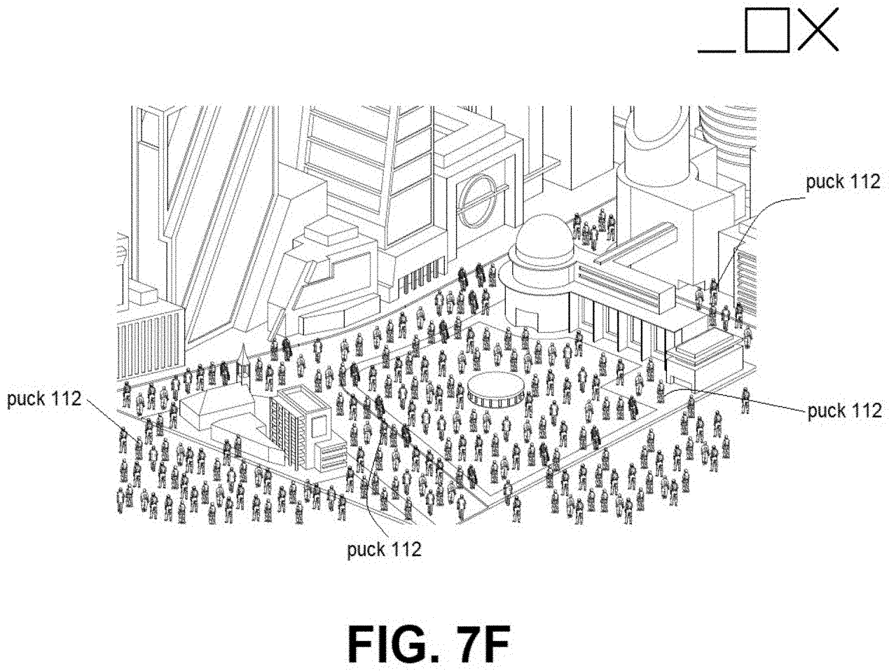

When no GPS signal is available, the 3D display/controller 240 maintains relative location and provides the additional orientation to the ensemble from a digital compass 212, integrating accelerometer, or other mechanism of obtaining an estimate of compass heading for the system of transceivers located within the mobile units. This capability provides critical location information to mobile units in potential GPS-denied operating regions such as damaged or burning buildings, tunnels or collapsed structures due to natural or manmade disasters, and also where enemy combatants may have the ability to block GPS signals. The display/controller 240 includes a three-dimensional unit location GUI embodied by the master dashboard GUI viewer 154 supporting individual unit functional status and human puck-bearer health status. Some non-limiting example GUIs for the master GUI viewer 154 are shown in FIGS. 7A-7F, which also provide example potential usages for the system 100.

The following provides a non-limiting overview of some of the components shown in FIG. 2 brick/puck 108/112.

FPGA 216—In an embodiment, the FPGA 216 implements the functions of a Reed-Solomon FEC scrambler/descrambler and interleaver/deInterleaver. This is used to provide a periodic time in the duty cycle for each brick/puck mobile unit 108/112 to communicate with the master display/controller 240. Probability of detection is reduced by generating maximum-distance separable codes. An adversary will be unlikely to be predictive of an exact duty cycle needed to search for the transmitted signal from any given mobile unit. Further, even when a particular brick/puck mobile unit 108/112 is detected, the essential information in its message cannot be decoded without access to the other units' messages and a means to decode them.

JTAG 208—The JTAG or Joint Test Action Group is an industry standard for verifying designs and testing printed circuits. The JTAG 208 in FIG. 2 is a hardware interface that implements a method to communicate directly with the FPGA 216 or other integrated circuits. The JTAG 208 provides a means for testing the circuit implementing the various embodiments.

A2D-D2A 220—In an embodiment, the A2D-D2A 220 supports 12 bit communications at 100 Mb/sec. While proper operation of the system 100 and the ad-hoc network 116 is not tied to a particular number of bits of resolution or frequency, these setting are an example that achieve the claimed performance. Thus, the various embodiment herein should not be considered as limited solely to these example features.

Transceiver 224—The transceiver 224 comprises a low-noise amplifier feeding a power amplifier. Very low average RF power levels result from extremely short duration high-power pulses. These short-duration, high-power pulses are capable of penetrating building concrete walls and soils above tunnels, yet still maintaining a low average power.

In order to maintain a valid geolocation estimate between the mobile units 108, 112 in the ad-hoc network 116, an adaptive machine learning process predicts and compensates for certain types of errors. There exist at least two approaches for solving such errors. A first is where errors are corrected through block coding, and a second is where errors are quantified based on a short sequence of bits encountered thus far (called convolutional coding).

The system 100 instead uses the adaptive machine learning process that predicts compensating parameters based on multiclass decision criteria and is thus more generally usable and adaptable than either of the above approaches. These error-correcting codes achieve a broader solution through a machine learning process, including but not limited to inductive learning.

Rx/Tx Switch 240—In an embodiment, the receive/transmit switch 240 is controlled by DSPs and selects one or more appropriate antenna elements from the phased array antenna 236 to transmit and/or receive signals within the designated time period of a duty cycle of the system 100.

Phased Array Antenna (PAA) 236—To keep this disclosure readable and not impede logical flow, this section provides only a top-view summary. Further detail on the PAA 236 will be found elsewhere in this disclosure.

In an embodiment, the phased array antenna 236 is comprised of a 4 by 4 element pattern. This exemplary configuration allows beam steering and the ability to attenuate by a factor of from 1000->1 million any unwanted signals originated from directions other than where the computational resources are directing the main beam. This lowers the probability of interference when receiving, and likewise lowers a probability of transmission detection and interception of the system 100, as most of the transmitted power is directed in a relatively narrow band, and in only a single direction.

Weight for the phased array antenna 236 is of little concern, inasmuch as the array 236 can be fabricated from lightweight plastic and vapor deposited layers of a few microns of atomized silver. At 100 Kbits/s and 64 QAM with a bit probability error rate of 6×10⁻⁶ and a 5 dB final signal-to-noise margin, reliable communications can be assured for the system 100. Increasing power supplied to the PAA 236 can result in even higher data rates, but at the possible expense of increasing the probability of detection by an adversary.

It is anticipated that numerous different phased antenna arrays 236 can be used to satisfy a variety of different applications, including for example military, special forces, fire-fighting, law enforcement, crowd control and riot control, as well as many other applications of which only some are shown in FIGS. 7A-7F. These phased antenna arrays 236 may differ in amount of antenna elements, amount of power required to drive them, and other factors.

Machine Learning Processing—The ensemble (PNT) data from all units within the ad-hoc network 116 is collected and maintained by the display controller 240. The display controller 240 monitors the performance of all units, generates the 3D locations for the set of units, and detects and flags outlier (defective or impaired) units. In an embodiment, the monitored data is processed by a machine learning system (e.g. a Boltzmann machine) that anticipates the signals and operations data coming from each unit. When actual data being collected deviates from expected in a manner other than simple stochastic variation (e.g. measurement noise), the patterns in these data are matched to known prototypes (models) used to alert system operators of the possibility of a hazardous or anomalous condition. Examples include the presence of ionizing radiation, explosions, along with thermal and electronic or mechanical (e.g. seismic) disruptions.

System clock 204—The system clock 204 is an important component of the ad-hoc network 116, as an accurate reliable time-base is critical to achieving good communications between the mobile units. That means that the system clock 204 must not vary whatsoever. In an embodiment, the system clock 204 is driven by a temperature-controlled crystal oscillator (AKA TXCO) hereinafter referred to as 204_{co}.

In such an arrangement, that TXCO oscillator 204_{co} must not change frequency, no matter what happens to it. For the embodiments herein to work properly, the oscillator must consistently stay at the same frequency. One way to achieve that is to put the crystal oscillator in a heat bath and carefully maintain that heat at a known temperature, thus explaining the expression “temperature-controlled”. As long as that chosen temperature is above the ambient temperature of the active operating region (theater), one can adjust the temperature so that it never changes. Therefore, the crystal oscillator's frequency won't change, thus maintaining that temperature and ensuring permanent stability and constant frequency to drive the system 100. Again, this is important because if the frequency system clock 204 drifts, the system 100 loses accuracy and may entirely fail.

Thus, using a thermal controlled crystal oscillator (TXCO) for the system clock 204 means that no matter how the dude's running around with his puck 112 whether in the desert or in Alaska, that system 100 is always going to oscillate at a known frequency. However, it is difficult to maintain electric components in a carefully calibrated heat bath, especially when riding around inside a wearer's shirt or jacket such as with the puck 112.

Thus, the accurate time-base for the system clock 204 could be provided in a variety of other ways. For example a chip-scale atomic clock 204_{ac} provides accuracy approaching 100 times that of a typical crystal oscillator. In another embodiment, two clocks could be used on each unit, thereby improving the accuracy by a factor of two or three.

Computational Control—Many aspects of the system 100 are controllable using computational rather than fixed hardware components. These computational processes are distributed among the FPGA 216, the microprocessor and a number of DSPs. The FPGA 216 uses a measurement of the temperature to automatically adjust the count for range estimates and to maintain a match between oscillator and the transmitter. In order to ensure that the embodiments only transmit a burst of energy during the proper time period, the power supply for the power amplifier is switched on and off between bursts.

This ends the non-limiting overview of some of the components of the brick/puck 108/112.

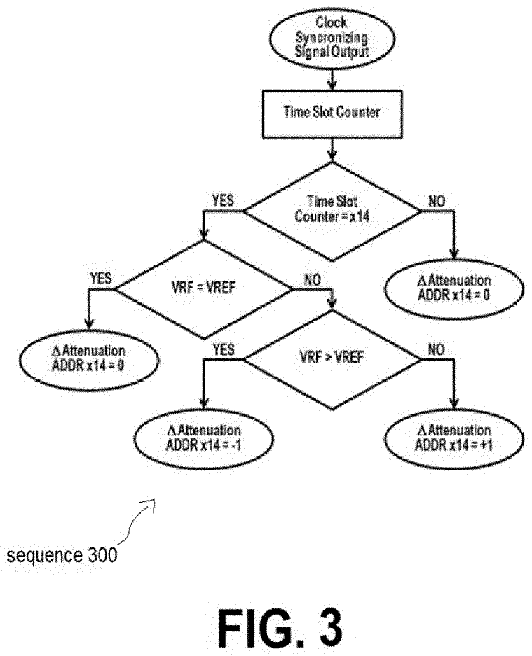

A non-limiting example operation sequence 300 of the FPGA 216 processing is shown in FIG. 3, showing steps in the Automatic Gain Control (AGC) algorithm 300 for a hypothetical receiver number 20. As long as the clock synchronizing output for receiver 20 (X14 hexadecimal) is high and the counter==20 decimal, the signal from the radio frequency receiver is input into the receiver FPGA 216 and converted into a 12 bit word. The AGC algorithm in the FPGA 216 measures the RF signal, checks whether the RF peak-to-peak voltage is equal to the reference voltage in the AGC feedback loop. If so, it leaves the attenuator setting as-is, unaltered. If the RF voltage is greater than the reference voltage, the count is decreased by 1. Meanwhile, if the RF voltage is less than the reference voltage, the count is increased by 1.

The AGC sequence 300 thus regulates the attenuation of the RF receiver chain so that the output RF detector voltage going to the FPGA 216 remains within the voltage range that is compatible with the CMOS circuitry of the FPGA 216. In this way, timing variations in detecting the RF signal are essentially eliminated due to a slew rate of the incoming CMOS signal being the same as the FPGA 216. In order to ensure that noisy RF signals are not amplified, when a comparator in the FPGA 216 detects incoming signals below a predetermined threshold, the attenuation levels are set to 0.0 Volts.

In one embodiment the BPF 228 uses a surface acoustic wave (SAW) filter to maintain transceiver frequency control, achieving e.g. 109.2 MHz frequency with 70 dB attenuation at 100 KHz from center frequency. In another embodiment, a frequency of the BPF 228 is controlled computationally using a fast-Fourier transform (FFT) mechanism, thereby allowing computer control of both the transmitter and receiver frequencies of operation.

By using such computational processes, the timing of the transmit and receive operations is controlled, thereby enabling beam forming. Through this timing, the phased antenna array 236 can be electronically steered to “look” in any direction.

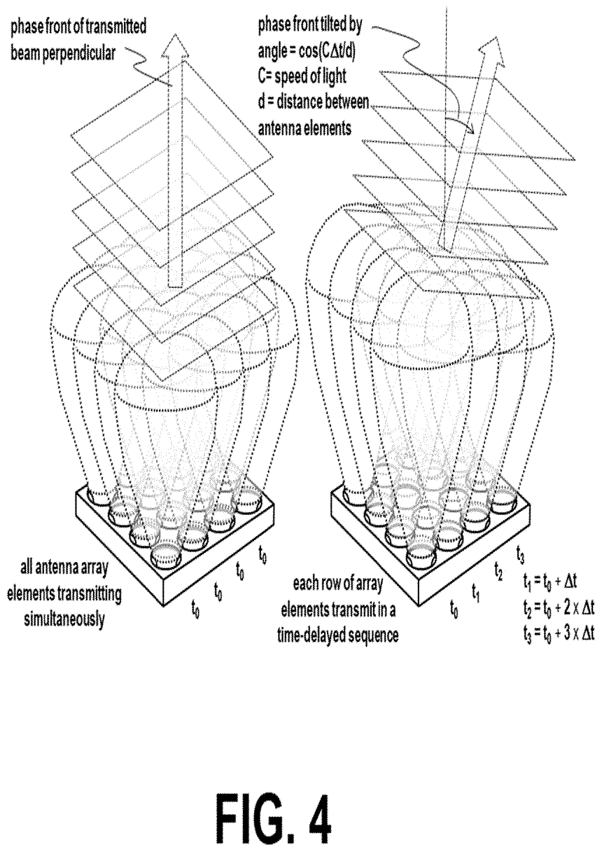

FIG. 4 shows an example where the PPA 236 is a 4 by 4 arrangement and has a fixed angular resolution of 58 degrees, but this is for example-only and for convenient illustration. The computationally controlled beam forming allows for interpolated operation achieving angular resolutions at least 10 times more precise, e.g. 5.8 degrees. However, to best illustrate the embodiments, it was necessary to pick an example angular resolution that can show up well in a patent drawing.

### Phased Antenna Array 236

As stated, the phased antenna array 236 is a complex device that requires a separate explanation just by itself. Rather than an omni-directional antenna, the embodiments herein use an azimuth and elevation beam forming, electronically-steered phased array antenna 236. Thus, unless the receiver antenna and transmitter antenna are pointing in coincident directions with their electronically directed beam steering electronics, any beams generated will be off-axis so that no signal will be received.

Since the beam is electronic (no mechanical moving parts) it can be redirected without mechanical delay to steer and scan all of the elements of the antenna in a hemisphere in front of the antenna array. In another embodiment, the sweep in one dimension can be electronic while mechanical actuators (such as piezoelectrics) are used for tilt, being operated simultaneously with the electronic scan so that a total scan time can be reduced compared to a two-dimensional mechanical scan.

Next, a resolution cell is an angular or spatial extent inside of which two objects cannot be distinguished from a single object. For example, two aircraft could remain so close to one another that they could not be resolved. That is, because they were within a single resolution cell they appeared to the radar as a single aircraft. Applying this to the embodiments herein, for each scan element of the phased antenna array 236, only one range of signals of receiving azimuth and elevation angles will generate a signal. Thus the azimuth-elevation angles of the phased array antenna 236 are correlated to only one antenna element per resolution cell.

At the start of each mission, e.g. raid on a compound, fire-fight, or other emergency, each transceiver 224 is synchronized to the system clock 204, whether system clock 204_{co} or 204_{ac}. For example, supposing each transceiver's individual clock is stable to +/−1 ppm per month over a temperature range of −40° C. to +80° C., individual transceivers can be assigned a different time slot of 20 micro-second during which time it will only receive from the central antenna element (only the central element is turned “ON”), in order to insure that only 16 micro-seconds are required to acquire a signal being transmitted. Once communication is established, the two transceivers 224 will maintain a communication link via computer-controlled protocol, since now their two respective antennas will continue pointing towards each other. The signal amplitude/beam steering position electronics and feedback firmware described herein assure that this remains the case.

At another predetermined time interval, determined by a mission time slot for each transceiver 224 within each brick/puck 108/112, a 10 micro-second pulse is transmitted. Since all transceivers are synchronized to the same master system clock 204, the intended receiving transceiver whose received beam forming element is directed toward the activated transmitter can simply count the time to receive the transmitted pulse. So in an example of 3333 nano-seconds, or 1000 counts for a 300 MHz count clock, this equals the time required to count off 1000 meters since the speed of light is close to 3×10⁸ meters/sec. So within a four by four arrangement of antennas within a phased antenna array, it is possible to shut off 15 of the 16 antennas at any given time.

Various of the following processes assist in ensuring good performance and adaptability to a wide variety of specific purposes for the phased antenna array 236:
1) Include dipole elements chosen using a high-frequency structure simulator. Non-limiting examples can include but are not limited to Ansoft, or CST Computer Simulation Technology;
2) Include an Active Element Pattern (AEP) method of beam steering, whereby only one element of the antenna array is active at a time, the others being terminated to a geometric mean impedance of the array. In one example embodiment, only 1 of 16 elements would be active;
3) Calculate a pattern multiplication of the antenna array through simulation; and\or
4) Optimize the phased antenna array 236 for beam steering. Compare and test various element signal amplitude tapering methods including binomial, uniform, and Chebyshev across the one or more phased antenna arrays 236.

### Atomic Clock 204_{ac}

Atomic clocks were mentioned earlier, but only summarized. A more detailed explanation is now provided. Atomic clocks 204_{ac} are useful within the system 100 because they gain accuracy at higher frequencies. Since light waves have frequencies about 50,000 to 100,000 times a typical cesium microwave frequency, shifting to a light-based clock is much better.

It is possible to have at least three types of atomic clocks. While they are all optical clocks, they have different physics. A calcium clock gains accuracy by averaging the signal from millions of atoms. A mercury ion clock, on the other hand, requires control of one—and only one—atom of mercury. One of the requirements for an atomic clock is that the atomic resonance must be insensitive to environmental influences, such as electric and magnetic fields. But that also means these atomic resonances are then difficult to actually use in clocks. That gives rise to the third option, cesium-based atomic clocks, which can help solve these issues.

This is because one way of counting light waves is a frequency comb, which is a spectrum of light generated with a special laser, which looks like the teeth on a hair comb. These teeth are discrete frequencies at regularly spaced intervals. The spacing between the teeth can be measured precisely with a cesium atomic clock. By counting off the teeth one-by-one—even though there are thousands of teeth—one can scale up from microwave frequencies (where the cesium clock works) to optical frequencies. Frequency combs can also compare two optical frequencies to each other.

One of the most direct examples of atomic clock usefulness is in the measurement of electrical voltage. It is possible to realize a Volt by using a device called a Josephson Junction (JJ), which has a direct proportionality between the microwave frequency used with the JJ device and the voltage it puts out. Once a microwave's frequency is known, the voltage of that microwave is also known. As such, using chip-scale atomic clocks in high-end voltmeters for such frequency measurements makes high-precision voltage measurements more ubiquitous.

One of the requirements for an atomic resonance to be useful as a clock is that it had to be insensitive to environmental influences like electric or magnetic fields. However, it is also possible and potentially advantageous to connect a chip-scale device to an atomic resonance that is highly sensitive to its environment. While that makes it a bad clock, it can make it a great sensor. If something is affecting the speed or the frequency of this clock, these events that made it makes it difficult to make a good constant highly accurate time base, these same events can be measured by using that clock.

In processing communication signals, it is often necessary/helpful to computationally compensate for shifts in frequency, time, the vagaries of temperature, electric fields, and magnetic fields. Monitoring these externalities can help distinguish between just the casting of random fluctuations and pattern fluctuations from crusher (serious) fluctuations. Using machine learning to extract knowledge about that event, e.g. a certain at a speed of sound or twice the speed or sound, some fluctuation that rips through all the units, it will then be known where the units are distributed in space.

Based on the amount of fluctuation and the type of fluctuation, someone could probably survive what happened so that if 2000 tons of potassium nitrate exploded on the shipping docks of Beirut such as in July 2020, everyone that had one of these atomic clocks 204_{ac} in their version of a system 100 would register that a large (crusher) event occurred. Instrumentation could take the timing between them all as it were already coupled, and then determine an approximate level of damage. This in turn would enable quickly sending out a potential first responders, or have people move in a different direction away from the event.

At some point, these chip scale time basis are soon going to be available on cell phones, especially with the advancement of 5G networks. Once that happens, it becomes possible to couple all cell phones together with a common time base, and use any fluctuations on individual cell phones to do the same measurements discussed earlier.

The atomic clock 204_{ac} thus enables a highly accurate time base which in turn can result in improving many different important voltage measurements. Any kind of electromagnetic fluctuations like EMV, or any ionizing radiation that causes a shift, accurate measurements are important. Thus, the number of applications is close to unlimited. Once this same technology is included into a cell phone, the applications will increase as everybody will have one. As such, a typical mobile device could be another “mobile unit” as that term is used herein, along with the bricks/pucks 108/112.

One example given above is explosions, but could also apply it to gunshots. If there's an acoustic wave that causes the fluctuation or acoustic wave that can be picked up by another sensor on the same device, and then using the accurate time base, a measurement can be extracted. Potentially, the type of gun can be determined.

However, a small-scale gunshot may or may not generate a sufficient shockwave to disturb an atomic clock. Still, acoustics could make up this gap. That is, with the clocking from either the TXCO 204 or atomic clock 204, one can correlate the gunshot sound coming in just through a microphone, to a spatial location relative to each device (e.g. puck 112 or mobile phone). Because the shockwave from the gunshot will reach each mobile unit at different times. This is a way of detecting events using acoustic measurement of disturbances.

However, as stated, the embodiments herein go beyond only acoustics. As stated, the atomic clock 204_{ac} works at the speed of light. The gun-shot example is merely to provide an alternative for detecting low-level disturbances that might not be strong enough to disrupt an atomic clock (atomic sensor). For greater accuracy (sub-meter range), a faster atomic clock 204_{ac} can be used.

Thus, using the relative timing of the RF signals, it becomes possible to determine a location of the puck 112 in three dimensional space. The determination of where the puck 112 is in a first responder (puck bearer) situation is important in case the wearer is dying or has smoke inhalation or needs help or something; or on the battlefield, is not moving and is not responding. That will give a quick indication there's probably something wrong, as well as where the “wrong” as located.

In an embodiment, a spatial resolution of less than 1 square centimeter at 100 feet of radar range and less than 10 microWatts average power is achieved by the inventive transceiver configuration (ad-hoc network 116) described herein. An equivalent resolution can be achieved at 1000 feet radar range using a power level of less than 0.1 Watts. This can be accomplished through the use of very low noise amplifiers (LNAs) exhibiting approximately 8 dB of receiver noise in combination with unique artificial intelligence and machine learning detection algorithms embedded in one or more of the FPGAs 216 or other embedded processor. Again, if even greater accuracy (sub-meter range) is desired, a faster atomic clock 204_{ac} can be used.

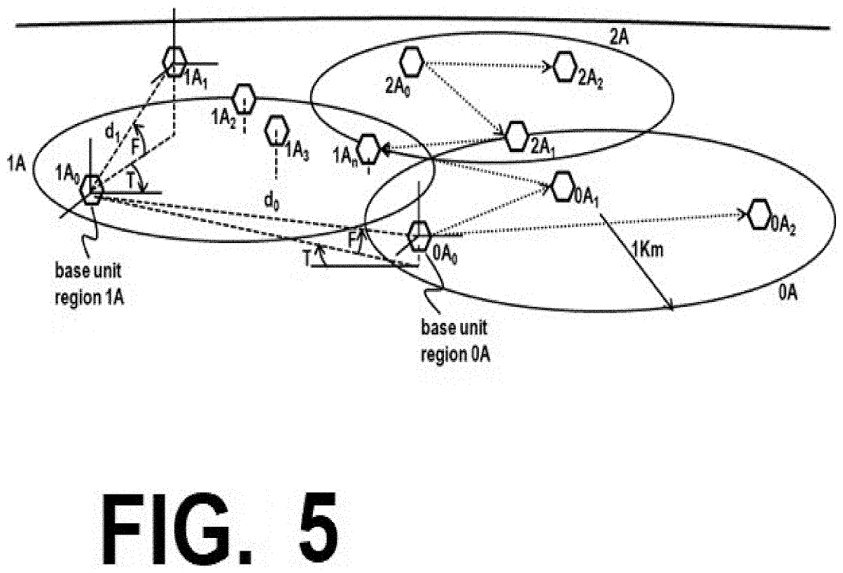

Once two transceivers 224 have communicated, their distance, azimuth degrees, and elevation degrees are known, but (at first) only with respect to each other. FIG. 5 shows this in more detail. That is, if one transceiver 1A0 is assigned to be base or master transceiver for a particular 1 Km radius area (call it area 1A), it can record/transmit the distance, azimuth and elevation angles (d0, θ, Φ)_{1A} of each transceiver in that 1 km radius of 1A0. Note that given (d, θ, Φ)_{1A} of a transceiver in area 1A (that radio being termed 1A1) with respect to 1A0, the position of the transceiver 1A1 with respect to 1A0 is known. The same holds for transceiver 1A2 or transceiver 1A3 or transceiver 1Aₙ, where “n” is the “nth” transceiver in the area 1A. Similarly, for a 1 km radius area of 2A, master transceiver 2A0 can record/transmit the position of a transceiver 2A1 or transceiver 2A2 or transceiver 2An in area 2A with respect to 2A0. In order for GPS base OA0 to determine the position of 2A transceivers with respect to itself, it will require a translation algorithm to translate 2A coordinates to OA0 coordinates. This can be achieved through standard geometric calculations for small regions and using standard methods common to GPS based geolocation.

An example where such geolocation could be important would be a large group of people in a crowd start rushing into one direction. With some fraction of them not moving at all, it tells you there's probably something lethal happening that the crowd is trying to avoid, such as a first person shooter or a type of armed intruder, a poison gas situation, or something resembling the Cincinnati 1979 trampling situation at a “Who” concert. Or an active shooter at a school at a hospital at a military base. Suddenly it seems like . . . it's unusual for a kindergarten class to all be running full speed down a hallway. This is not their bathroom break time, and they're moving awfully fast. That looks a little suspicious. The embodiments herein could, with the right configuration, eventually detect that.

Interestingly, such a crowd, whether kindergarten or protestors, need not all be wearing the pucks 112. Not necessarily. With a better time-base, e.g. 5G-based mobile devices that may have some version of an atomic clock, that mobile device becomes a puck-like presence. Typical mobile devices have the RF capabilities to be a mobile unit as that term is used herein, but what they lack is a synchronized time base. However, as shown elsewhere herein, atomic clocks are becoming so ubiquitous that they may soon be found within a typical conventional mobile device worn or carried by anyone, of any income level. If so, the embodiments herein with the atomic clock 204ac therein would resolve the time-based issues either mobile devices or pucks 112. This in turn might make detecting when normal crowds turn into emergency crowds infinitely easier to predict, route, block, and generally achieve crowd-control.

In such a situation, the embodiments herein could send out troops or emergency responders. If one set up an alert to get there now as a contingency, and let them know whether to turn around and go home. It would be traveling in that direction and they will be informed whether it's an authentic emergency event, or whether it's a misunderstanding. An “all clear” would mean to stand down.

### Business Model

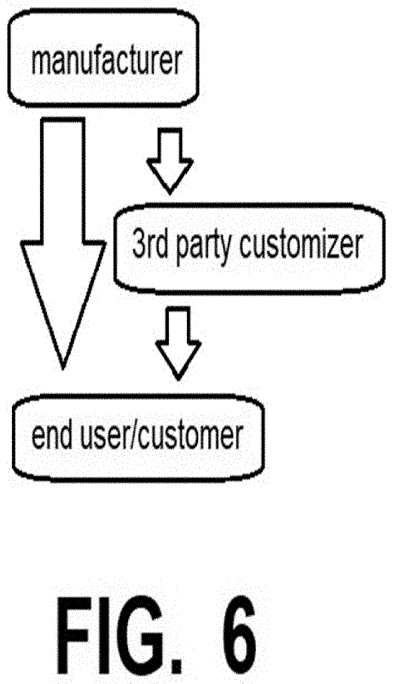

For each different usage of the system 100, it will be necessary to write customized computer code to help configure the FPGA 216. There are a number of different ways to achieve this, as illustrated in FIG. 6. An original manufacturer can offer turnkey products, a 3rd party customizer could provide solutions, or the end-customer could make their own custom-version.

In all cases, the code developer would write in e.g. the C++ language and store it into the FPGA 216, where that code gets turned into machine language. That code developer would write C++ high level language, and then a burner or compiler would load it into the FPGA 216. Because of specific beam forming structures, there are certain ways of doing beam forming using the phase array antenna 236 where writing customized code is necessary. That code sits mainly inside the FPGA 216 to do that certain specific task.

The low level processing to assess timing of the components within the ad-hoc network 116 is done in the FPGA 216. These timings are then sent along through the DSPs to the beam formers 232 to the band pass filters 228. The timings then get sent to the beam former 232. All these specific timings get calculated in the FPGA 216.

For example, as shown in FIG. 6, a manufacturer who writes one set of FPGA code for beam-forming and whatnot for first responders and fire fighters. That manufacturer could then write a second completely different configured set of C++ code to sit on the FPGA 216 for defense or military, and then a different third set for e.g. police or law enforcement.

If an entity is building a system 100 for a first responder and they're inside a building and they're trying to see through walls, that requires a first specific timing. This timing would however be different for somebody in a helicopter trying to find tanks at the edge of a field, e.g. in a tree line. One desired range of applicability might be at a kilometer, while another might be at five feet.

Both of these ranges are achievable within the embodiments herein, but someone within FIG. 6 would have to change the energy levels and the timings and the resolution and the frequency shifting within the separate ad-hoc networks 116. That changing would be new code that gets stored into various of the FPGAs 216.

### Beam Forming

Beam forming is an important feature of the embodiments herein, and thus requires further explanation. Beam forming is achieved by the phased antenna array 236 and utilizes a time filter. The band pass filter 228 acts as a frequency filter. It is possible to shift the frequency for separating what is desired to see from what is not desired to see. So components tune to a desired frequency suitable for reception. And the beam forming helps determine when a particular element is going to receive or send a big burst of energy. And that essentially allows pointing (steering) of a beam. Using such steering, the phased antenna array (PAA) 236 can look any particular direction or send the beam in a particular direction without having to physically move that phased antenna array 236.

By way of example, assume the PAA 236 is looking off at a 45 degree angle and sending a beam out in that direction and is looking at direction for a return. Then, one can sweep that same beam to the other side, without any physical motion of any mechanical parts, just by shifting the timing of that beam forming signal. Then, collect what would be the return signal. So that the beam that came in from the other direction at 45 degrees, should hit the intended PAA 236 at the same time. Anything coming in from the other direction is hitting the PAA 236 at a different time, and thus gets rejected. That's the way the phased antenna array 236 works.

Another concept is only looking in a very small part of the duty cycle. Each of the antenna elements in the phased antenna array 236 is either transmitting or receiving, although individuals that are sending and receiving in all directions. The only time they're going to be looking is when relative to the others, the beam would be coming in from a particular direction. Then they all see it. If they all see it, then get the thumbs up and accept that signal. Otherwise, they just ignore it.

All the elements (e.g. 16 elements) within the PAA 236 are always going to receive all the signals, but unless they all come in at the exact right time, those signals get ignored. Only look at a particular time so that the ensemble of all 16 get hit at the right time. Then, it is known what angle that beam came in from.

In an embodiment, a puck-bearer will have a Marconi antenna running down the person's leg, e.g. having a rod or a single wire antenna on the pant leg. But that achieves range only, yet still doesn't know anything about direction. The PAA 236 improves this and allows having a puck 112 strapped to the worker to give improved information about relative and actual position of that person.

Additionally, an embodiment of the PAA 236 may use 25 elements instead of 16, or make it circular array of elements and make the math a little more involved, if advantageous. Thus, the 4×4 PAA 236 is used only as working example, but by no means will the embodiments herein be limited to just 4×4.

In an embodiment, the phased array antenna 236 could detect position of a puck 112 through 1.5 feet of concrete. Each puck 112 could determine its own location relative to the others, but they couldn't project into another location to see things that weren't punctured. Meanwhile, the phased array antenna 236 allows getting return signatures from blobs and noting “ . . . that's a fleshy thing, that's an iron thing, that's a concrete thing”. Moving the PAA 236 around might not enable seeing people's faces, but can see something that acts like a human body. Pointing the phased antenna array 236 could shift mechanically or electronically through a region and spectrum and generate a blobby image of something, like colored blob in a dark background.

### Stealth and Power Reduction

With the addition of the phased-array antenna 236, additional attenuation is achieved against any incoming signals that are not aligned with the main beam steering. This greatly improves the anti-jamming capability of the system 100. Digital signal processor-based broad null beamforming methods can achieve interference reduction. Alternatively, a beam can be steered by simply varying the delay of the received signal from the elements. The mode of operation of the system 100 combined with the AI signal processing discussed herein further enhances interference reduction to achieve low-probability of detection, ground and wall-penetration and an ability to operate in passive and active signal denied environments.

The range performance can be adjusted by setting the power level and signal frequency. The practical frequency capability of a transceiver can range from 100 MHz to 1000 MHz. At 870 MHz an example power level of 0.07 Watts provides an operating range exceeding 1000 feet, through concrete walls. At a power level of 7 Watts the transceiver range can be extended to over 1 kilometer.

An artificial intelligence (AI) based frequency signal processing technique permits operation at power levels low enough to provide an effective stealth mode which also helps to defeats jamming and detection since the duty cycle is 1/1000. This means that the transmitter is on for only 1 millisecond for each full second of operation. The particular 0.001 second is selected at a pseudo-random time, making the signal extremely difficult to detect by an adversary. Because all the energy is contained in the very short bursts, it can penetrate an 8″thick steel-reinforced concrete wall using only 7 microWatts of power with over 15 dB of signal-to-noise margin.

If users don't turn these various elements on and off at the right time, then the system 100 emits radiation, and may not be useful radiation. The system 100 doesn't want to be detected. However, these energy-bursts are very short and there's no energy emanation in between those bursts, so that the chances of somebody else detecting a brick 108 or puck 112, even if they're sitting there listening, they will not know what frequency to listen on. Further, they won't know when to listen. The system 100 is limited in frequency, a specific frequency is set by the band pass filter and a specific time is set by the FPGA 216 that ended up driving the beam forming. Thus, one can use frequency shifts and can time shift to keep the system 100 stealthy.

### Example Usages and GUIs

The following examples are not limiting, and only meant to clarify some possible applications of the embodiments herein. There could be many other applications not overtly stated below, and that may not even vaguely resemble anything below. One purpose of this disclosure is to explain the principles of the invention and how it works, using hopefully familiar scenarios such as city riots and looting, Bin Laden raid of 2011, Tehran raid of 1980, wildfires such as in Northern California. These scenarios are chosen examples because they are likely to be already familiar to a reader. However, these examples should not be considered limiting.

US Embassy in Teheran in 1980

This example is used because of its famosity and clear understandability, a legacy reference. Had US special forces reached the rooftops of the US Embassy in Tehran in 1980, they would have been confronted with numerous problems, one being of not knowing how to distinguish between hostages and hostage-takers.

The system 100 would have been helpful in this task, with its ability to detect human activity behind walls and reduce concealment. The hostage-takers would have been much more likely to try to conceal themselves from the U.S. special forces, while the actual hostages would clearly be more likely to run toward the special forces. FIG. 7A (Tehran) illustrates an example GUI showing what this might have looked like.

Further, even in regions where GPS signals are impaired or intentionally jammed, the master GUI viewer 154 would have always known where each of the special forces were located, a critical factor in a dangerous raid like that of 1980.

Bin Laden Compound 2011

The raid on the Bin-Laden compound (Pakistan) in 2011 is another similar example, except that in 2011 it may have been possible or at least more likely that Pakistan would have jammed or obstructed all usage of GPS. One advantage of the ad-hoc network 116 within the system 100 is that using the combination of digital compass 212 and atomic clock 204, the system 100 cannot be jammed. FIG. 7B (Bin-Laden compound) illustrates an example GUI of what such a raid might have looked like using the embodiments herein.

Wildfires and Fire-Fighters

Wildfires have their own special set of problems, one being the challenge in maintain any visibility of each worker, and a second being that GPS has difficulty in conditions of high heat. The master GUI viewer 154 operated by a coordinator near the fire-site but not directly in it, could assist in reducing both of these problems. FIGS. 7C and 7D illustrate this.

Again, unlike other solutions, determining the relative locations of each puck-bearer would be unlikely to be impaired by the high heat, partly because neither the digital compass 212 nor the atomic clock 204_{ac} would be affected by such heat.

Law Enforcement, Rioting, and Looting

Rioters and looting scenarios are an environment less likely to deny GPS, but GPS could still be impaired in a large city due to a lot of competing for GPS resources. Either way, the system 100 may be an improvement over other types of law-enforcement resources, in that the pucks 112 give a continuous update at least as to position and location of each puck-bearer, e.g. law enforcement or other resource.

Further, the atomic clock properties of the bricks 108 and pucks 112 could help locate gunshots, type of guns, where the shooting is originating from, and help make at least some sense of the general chaos. FIGS. 7E (street) and 7F (helicopter) attempts to illustrate this. FIG. 7E (street) shows the police being lined up together and clearly outnumbered by a much larger crowd. Meanwhile, FIG. 7F (helicopter) is a helicopter-level view of the same police line of FIG. 7E (street), but being immersed in that much larger crowd, yet their positions still viewable on the master GUI viewer 154.

What is claimed is:

1. A method of configuring a position-location system, comprising:
arranging a plurality of bricks, pucks, and a master viewer into an ad-hoc network within an active operation region;
the system communicating through the ad-hoc network;
wherein if a GPS signal exists within the active operating region, equipping the pucks and bricks with a GPS receiver that can convert a relative location information being received from the bricks and pucks into an absolute geolocation and heading which can then be re-distributed to all bricks and pucks throughout the ad-hoc network;
in situations where no GPS signal is available, maintaining a relative location and providing the additional orientation using a digital compass, integrating accelerometer, or other mechanism of obtaining an estimate of compass heading for the ad-hoc network, thereby achieving absolute geolocation and heading for all pucks and bricks; and
the display/controller including a three-dimensional location graphical display in the form of the master viewer supporting individual unit functional status and human puck-bearer health status.

2. The method of claim 1, further comprising:
a plurality of human workers wearing the pucks sewn or embedded within their clothing;
configuring the bricks with strong adhesive wherein one or more of the plurality of human workers, while initially running into the active operating region, posting a brick a predetermined distance off the ground while running into the active operating region; and
displaying locations of all of the plurality of workers within the master viewer for use by one or more supervisory persons.

3. The method of claim 1, further comprising:
in situations where no GPS is available, achieving position, navigation and timing of each brick and puck by utilizing a range timer controlled by a system clock;
translating a plurality of beam steering information thereby determining position and timing with respect to a local area base radio within the active operating region.

4. The method of claim 1, further comprising:
in situations where GPS is available, the ad hoc network furnishing position and timing of each of the plurality of pucks and bricks to an adjacent area and until one of the pucks or bricks is located outside of the GPS-denied region; and
the one puck or brick outside the GPS denied region conveying GPS info to all pucks and bricks.

5. The method of claim 3, further comprising:
during a situation where none of the elements of the ad-hoc network can get outside the GPS-denied area, obtaining accurate position for all of the plurality of pucks and bricks using a combination of a system clock and the digital compass.

6. The method of claim 1, further comprising:
configuring a phased array antenna with a 4 by 4 element pattern thereby allowing beam steering and the ability to attenuating a predetermined factor any unwanted signals originated from directions other than where the computational resources are directing the main beam, thereby lowering the probability of interference when receiving, and lowering a probability of transmission detection and interception of the system.

7. The method of claim 1, further comprising:
configuring the bricks and pucks to comprise a floating point gate array (FPGA) to manage the low-level processing and communications functions;
an Analog2Digital/Digital2Analog converter handling the incoming and outgoing signals through the transceiver; and
a bidirectional receive/transmit switch feeding an adaptive bandpass filter.

8. The method of claim 7, further comprising:
the FPGA performing low level processing thereby assessing and calculating a timing of the components within the ad-hoc network; and
sending the timing through the DSPs to the beam formers through to the band pass filters.

9. The method of claim 1, further comprising:
configuring the plurality of bricks to be substantially rectangular such that once the ad-hoc network is activated, the bricks are mountable on a vertical surface and then remain stationary.

10. The method of claim 1, further comprising:
configuring the plurality of pucks in a round disc-shape suitable to be sewn into clothing worn by the workers.

11. The method of claim 1, further comprising:
the puck or brick feeding a low noise amplifier and creating short duration high-power pulses using low average RF power levels such that the short-duration, high-power pulses are capable of penetrating building concrete walls and soils above tunnels yet still maintaining a low average power.

12. The method of claim 6, further comprising:
customizing a plurality of numerous different phased antenna arrays according to differing end-user applications, including but not limited to military, special forces, fire-fighting, law enforcement, crowd control and riot control.

13. The method of claim 12, further comprising:
the phased antenna arrays differing in amount of antenna elements and/or amount of power required to drive them.

14. The method of claim 5, further comprising:
the system clock achieving an accurate reliable time-base, not varying whatsoever, thereby achieving solid communications between all bricks and pucks in the ad-hoc network.

15. The method of claim 14, further comprising:
using a chip-scale atomic clock for the system clock.

16. The method of claim 6, further comprising:
for each of a plurality of different usages of the system responsive to an end-customer, writing separate customized computer code to help configure the FPGA.

17. The method of claim 16, further comprising:
an original manufacturer building and providing turnkey products to the end-customer.

18. The method of claim 16, further comprising:
a third party customizer providing solutions for the end-customer.

19. The method of claim 16, further comprising:
the end-customer could making their own custom-version.
